(19) United States
(12) Patent Application Publication
(10) Pub. No.: US 2026/0343619 A1
(43) Pub. Date: Oct. 29, 2026

(54) INITIAL ACCESS FOR MULTIPLE TRANSMISSION AND RECEPTION POINT SYSTEMS

(71) Applicant: QUALCOMM Incorporated, San Diego, CA (US)

(72) Inventors: Xiaoxia ZHANG, San Diego, CA (US); Tao LUO, San Diego, CA (US); Junyi LI, Greentown, PA (US); Jelena DAMNJANOVIC, Del Mar, CA (US); Mostafa KHOSHNEVISAN, San Diego, CA (US); Wooseok NAM, San Diego, CA (US); Sony AKKARAKARAN, Poway, CA (US); Navid ABEDINI, Basking Ridge, NJ (US); Jianghong LUO, Skillman, NJ (US); Qian ZHANG, Basking Ridge, NJ (US)

(21) Appl. No.: 19/192,059

(22) Filed: Apr. 28, 2025

(51) Int. Cl. H04W 74/0833; H04B 7/06

(52) U.S. Cl. CPC H04W 74/0833; H04B 7/06968

(57) ABSTRACT

This disclosure provides methods, components, devices and systems for initial access for multiple transmission and reception point (multi-TRP) systems. For example, a user equipment (UE) may receive a multiple synchronization signal blocks (SSBs). Each SSB may correspond to a respective transmission and reception point (TRP) of multiple TRPs of a network. The UE may transmit, in response to receiving the multiple SSBs, a first random access message, of an initial access procedure, indicating a respective signal strength for each of the multiple TRPs. The UE many receive, in response to transmitting the first random access message, a second random access message, of the initial access procedure, indicating a multi-TRP communication scheme that supports communication with the network via one or more of the multiple TRPs.

### TECHNICAL FIELD

This disclosure relates generally to wireless communication, and more specifically to systems, devices, methods, and techniques associated with initial access for multiple transmission and reception point (multi-TRP) systems.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving a set of multiple synchronization signal blocks (SSBs) each corresponding to a respective transmission and reception point (TRP) of a set of multiple TRPs of a network, transmitting, in response to receiving the set of multiple SSBs, a first random access message indicating a respective signal strength for each of the set of multiple TRPs, and receiving, in response to transmitting the first random access message, a second random access message indicating a multiple-TRP (multi-TRP) communication scheme that supports communication with the network via one or more of the set of multiple TRPs.

A UE for wireless communications is described. The UE may include a processing system that includes processor circuitry and memory circuitry that stores code. The processing system may be configured to cause the UE to receive a set of multiple SSB each corresponding to a respective TRP of a set of multiple TRPs of a network, transmit, in response to receiving the set of multiple SSBs, a first random access message indicating a respective signal strength for each of the set of multiple TRPs, and receive, in response to transmitting the first random access message, a second random access message indicating a multi-TRP communication scheme that supports communication with the network via one or more of the set of multiple TRPs.

Another UE for wireless communications is described. The UE may include means for receiving a set of multiple SSBs each corresponding to a respective TRP of a set of multiple TRPs of a network, means for transmitting, in response to receiving the set of multiple SSBs, a first random access message indicating a respective signal strength for each of the set of multiple TRPs, and means for receiving, in response to transmitting the first random access message, a second random access message indicating a multi-TRP communication scheme that supports communication with the network via one or more of the set of multiple TRPs.

A non-transitory computer-readable medium storing code for wireless communications is described. The code may include instructions executable by one or more processors (e.g., directly, indirectly, without pre-processing, after pre-processing) to receive a set of multiple SSBs each corresponding to a respective TRP of a set of multiple TRPs of a network, transmit, in response to receiving the set of multiple SSBs, a first random access message indicating a respective signal strength for each of the set of multiple TRPs, and receive, in response to transmitting the first random access message, a second random access message indicating a multi-TRP communication scheme that supports communication with the network via one or more of the set of multiple TRPs.

Some examples of the method, UEs, and non-transitory computer-readable medium described herein may further include operations, features, means, or instructions for receiving, via a system information block (SIB), assistance information corresponding to the set of multiple TRPs, where the first random access message may be based on the assistance information.

In some examples of the method, UEs, and non-transitory computer-readable medium described herein, the second random access message includes quasi co-location (QCL) information for each of the set of multiple TRPs and the method, apparatuses, and non-transitory computer-readable medium may include further operations, features, means, or instructions for communicating in accordance with the multi-TRP communication scheme based on receiving the second random access message and in accordance with the QCL information.

In some examples of the method, UEs, and non-transitory computer-readable medium described herein, the first random access message includes a third message of a four-step random access procedure and the second random access message includes a fourth message of the four-step random access procedure and the method, apparatuses, and non-transitory computer-readable medium may include further operations, features, means, or instructions for transmitting, in response to receiving the set of multiple SSBs, a first message of the four-step random access procedure and receiving, in response to transmitting the first message, a second message of the four-step random access procedure, where the third message may be transmitted in response to receiving the second message.

In some examples of the method, user equipment (UEs), and non-transitory computer-readable medium described herein, the first random access message includes a first message of a two-step random access procedure and the second random access message includes a second message of the two-step random access procedure, the second message received in accordance with a random access occasion (RO) for a group of UEs including the UE.

### BRIEF DESCRIPTION OF THE DRAWINGS

FIG. 1 shows an example of a wireless communication system.

FIG. 2 shows an example of a signaling configuration that supports initial access for multiple transmission and reception point (multi-TRP) systems.

FIGS. 3-5 show examples of timing diagrams that support initial access for multi-TRP systems.

FIG. 6 shows an example of a process flow that supports initial access for multi-TRP systems.

FIG. 7 shows a block diagram of a processing system that supports initial access for multi-TRP systems.

FIG. 8 shows a diagram of a system including a device that supports initial access for multi-TRP systems.

FIGS. 9 and 10 show flowcharts illustrating methods that support initial access for multi-TRP systems.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may communicate with a network using multiple transmission and reception point (multi-TRP) communication. For example, a network may use multiple TRPs (e.g., network entities, antenna panels, antennas, radio units (RUs)) to communicate with a UE, and the TRPs may correspond to (e.g., be connected with, provide communication using) a common central unit (CU), distributed unit (DU), or a combination thereof. Multi-TRP communication may support higher data rates than single-TRP communication and may support energy saving for communication between a UE and a network. In some implementations, to support multi-TRP communication, a UE in a connected state may communicate with a network to enable a multi-TRP communication scheme. For example, a UE and a network may be connected, and the UE may request, or the network may determine, to enable multi-TRP communication. However, enabling multi-TRP communication after a UE has entered a connected state with a network may occupy time, frequency, or processing resources, which could otherwise be used or other purposes. For example, a UE may be in an idle or disconnected state while performing an initial access procedure to join a network. Although the UE may benefit from multi-TRP communication during or after the initial access procedure, the network may not enable a multi-TRP communication scheme at the UE until after the UE has entered the connected state, which may also involve additional signaling overhead.

Aspects of the subject matter described in this disclosure relate to enabling multi-TRP communication during an initial access procedure for a UE. For example, a UE may receive SSBs from multiple TRPs of a network. The UE may report information about the TRPs (e.g., signal strength, cells, frequencies), which may correspond to the SSBs, to the network in a random access message of an initial access procedure (e.g., a first message, such as a MsgA, of a two-step random access procedure, a third message, such as a Msg3, of a four-step random access procedure). The network may use the reported information to indicate to implement or indicate multi-TRP communication in a second random access message of the initial access procedure (e.g., a second message, such as a MsgB, of a two-step random access procedure, a fourth message, such as a Msg4, for a four-step random access procedure). In some implementations, the network may indicate assistance information for the UE to use for the reporting using system information signaling (e.g., a system information block (SIB)), using an earlier random access message of the random access procedure (e.g., a second message, such as a Msg2, of a four-step random access procedure), or a combination thereof. In accordance with these and other examples, a network may therefore enable multi-TRP communication with a UE during an initial access procedure, prior to the UE entering a connected state with the network, which may allow the UE and network to use multi-TRP communication for messages corresponding to the initial access procedure (e.g., a MsgB, a Msg4, feedback messages), messages following the initial access procedure (e.g., without exchanging signaling for implementing multi-TRP communication during a connected state), or a combination thereof.

Particular aspects of the subject matter described in this disclosure can be implemented to realize one or more of the following potential advantages. In some examples, by enabling multi-TRP communication during an initial access procedure, the described techniques can be used to increase data rates and support energy savings for communication between a UE and a network. In some examples, by including assistance information for a UE to use to report on SSBs for multi-TRP communication, the described techniques can be used to increase the reliability and probability of success of enabling the multi-TRP communication between the UE and a network, as well as reducing processing at the UE.

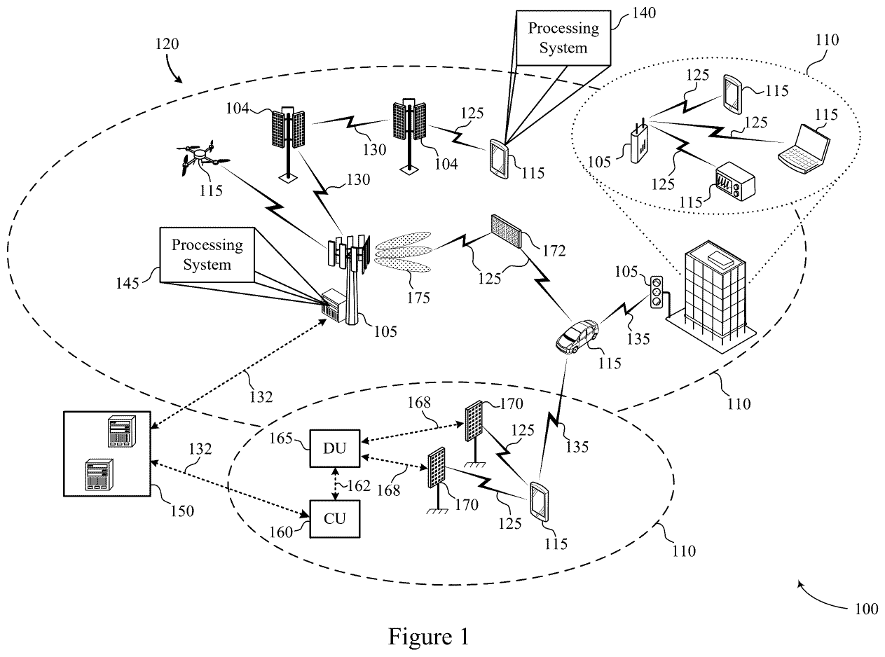

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number. A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, where the device may provide HARQ feedback in a specific slot for data received via a previous symbol of the slot. In some other examples, the device may provide HARQ feedback via a subsequent slot or according to some other time interval.

Devices of the wireless communication system 100 may be configured to support one or more aspects of the described techniques for initial access for multiple TRP systems. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support enabling multi-TRP communication during an initial access procedure for the UE 115. For example, the UE 115 may receive SSBs from multiple TRPs (e.g., multiple network entities 105, multiple RUs 170, multiple antennas, multiple antenna panels) associated with (e.g., corresponding to, indicating, transmitted by, received from, for configuring communication with) a network (e.g., a RAN 120). The UE 115 may report information about the multiple TRPs (e.g., signal strength, cells, frequencies), based on the SSBs from the multiple TRPs, to the network in a random access message for an initial access procedure. The network may use the reported information to indicate to implement multi-TRP communication in a second random access message for the initial access procedure. In some implementations, the network may indicate assistance information for the UE 115 to use for reporting on the SSBs in system information (e.g., a SIB) or in an earlier random access message for the initial access procedure. Thus, in accordance with these and other examples, a network may enable multi-TRP communication with a UE 115 during an initial access procedure, prior to the UE 115 entering a connected state with the network, which may allow the UE 115 and the network to use multi-TRP communication for messages corresponding to the initial access procedure, messages following the initial access procedure, or both. In some examples, enabling multi-TRP communication during an initial access procedure may increase data rates and support energy saving for communication between a UE 115 and the network. In some examples, including assistance information for a UE 115 to use to report on SSBs for multi-TRP communication may increase the reliability and probability of success of enabling the multi-TRP communication between the UE 115 and a network, as well as reducing the processing at the UE.

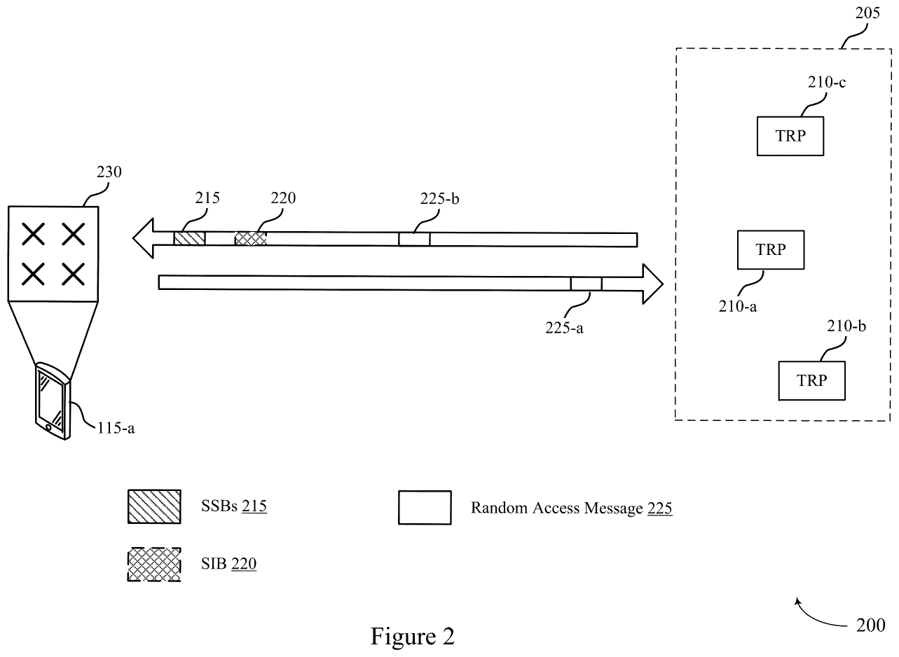

FIG. 2 shows an example of a signaling configuration 200 that supports initial access for multi-TRP systems. The signaling configuration 200 may implement, or be implemented by, aspects of the wireless communication system 100. For example, the signaling configuration 200 may include a network 205 (e.g., a RAN 120, a portion of a wireless communication system 100) including multiple TRPs 210 (e.g., TRPs 210-a, 210-b, 210-c) and one or more UEs 115, including at least the UE 115-a. The techniques described in the context of the signaling configuration 200 may support a network 205 to enable multi-TRP communication with the UE 115-a during an initial access procedure.

The network 205 may support wireless communication with the UE 115-a using a multi-TRP communication scheme, which may refer to communication between the UE 115-a and the network 205 using multiple TRPs 210. In some examples, a respective set of multiple TRPs 210 of the network 205 may be associated with a single network entity 105, such as TRPs 210 being respective antenna panels of a single network entity 105. Additionally, or alternatively, a single TRP 210 of the network 205 may correspond to a single network entity 105, such as a TRP 210 being an example of an RU 170. In some examples, multiples of such TRPs 210 (e.g., as multiple RUs 170) may correspond to a single CU 160, or one or more DUs 165, or a combination thereof. Thus, in accordance with these and other examples, multiple TRPs 210 of the network 205 may correspond to any quantity of one or more network entities 105. Using multiple TRPs 210 at the network 205 may enable multi-TRP (e.g., multi-panel, multiple network entity 105) transmission and reception at the network 205. In some implementations, the UE 115-a may also include multiple antennas or antenna panels 230. Such a configuration at the UE 115-a may allow the UE 115-a to enable multi-TRP communication schemes with the network 205 that may include simultaneous reception or transmission at the UE. Enabling a wireless device, such as the UE 115-a, to be served by multiple TRPs 210 may improve signal transmission and reception for the wireless device based on increased throughput.

Multi-TRP communication may implement space division multiplexing (SDM), frequency division multiplexing (FDM), time division multiplexing (TDM), and single frequency networks (SFNs). For example, TRPs 210 that implement SDM communication may utilize multiple spatial channels for simultaneous data transmission. Additionally, or alternatively, TRPs 210 that implement FDM communication may utilize multiple frequencies within a bandwidth for simultaneous data transmission. Additionally, or alternatively, TRPs 210 that implement TDM communication may send independent signals on a common channel at different times. Additionally, or alternatively, TRPs 210 that implement an SFN may each transmit the same information on the same frequency at the same time. In some cases, single-TRP communication may be considered a case of multi-TRP communication where one TRP 210 may be selected for some communications. In some implementations, multi-TRP communication may be intra-frequency specific. In some other implementations, multi-TRP operation may be extended across frequency layers (e.g., inter-frequency).

In some implementations, multi-TRP communication may be enabled after a UE 115 is configured in a connected mode (e.g., having established a communication link with the network 205, such as a communication link 125). In some other implementations, multi-TRP communication may be enabled during an initial access procedure, which may facilitate faster data rates after connecting to the network 205 and a quick ramp up to full data rates, as well as energy savings based on performing communication efficiently using a multi-TRP communication scheme and integrating the multi-TRP enablement in the signaling for the initial access procedure, rather than via separate signaling. For example, the UE 115-a may receive SSBs 215 from multiple TRPs 210 associated with the network 205. For example, each TRP 210 may transmit an SSB 215, which may be received by the UE 115-a. In some implementations, the network 205 may transmit (e.g., from one or more of the TRPs 210), via an SIB 220, assistance information for reporting on the SSBs 215 for multi-TRP communication. The UE 115-a may report information about the TRPs 210 (e.g., signal strength, cells, frequencies), based on receiving the SSBs from the TRPs 210, to the network 205 in a first random access message 225-a for an initial access procedure. The network 205 may use the reported information to implement or indicate multi-TRP communication in a second random access message 225-b for the initial access procedure. Such techniques may support indicating aspects of a multi-TRP communication scheme as part of a communication establishment between the network 205 and the UE 115-a, such as an establishment of a communication link 125 that supports multi-TRP communications.

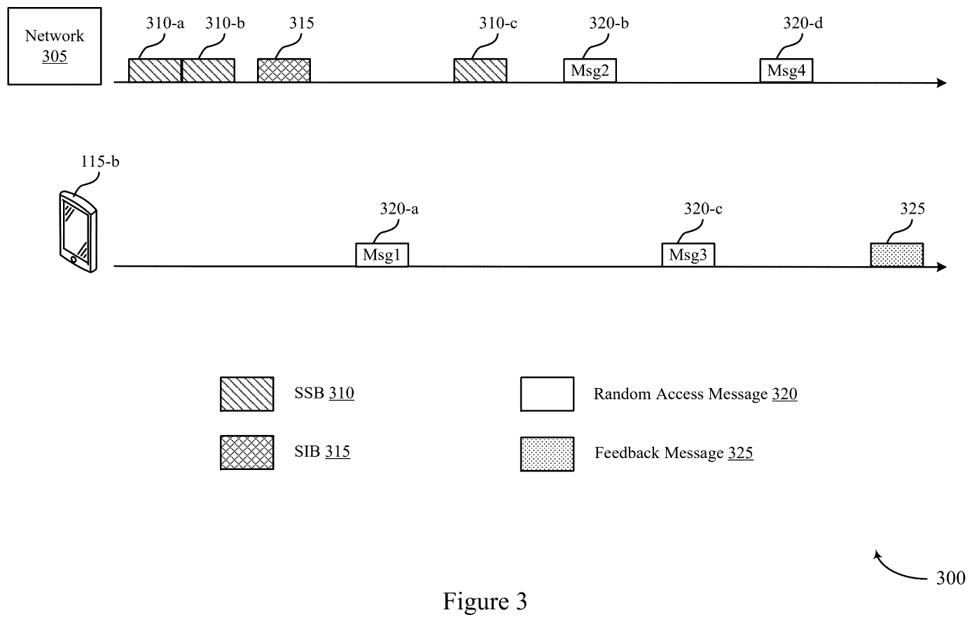

FIG. 3 shows an example of a timing diagram 300 that supports initial access for multi-TRP systems. The timing diagram 300 may implement, or be implemented by, aspects of the wireless communications system 100 and the signaling configuration 200. The techniques described in the context of the timing diagram 300 may support a network 305 (e.g., an example of a network 205) enabling multi-TRP communication with a UE 115-b during an initial access procedure, such as a four-step random access procedure.

In some examples, the UE 115-b may communicate with the network 305 for an initial access procedure. For example, the network 305 may transmit (e.g., using one or more TRPs 210) one or more SSBs 310, such as SSB 310-a and SSB 310-b. The UE 115-b may measure the SSBs 310 (e.g., signal strength, timing). In some implementations, the SSBs 310 may be sent from different TRPs 210 of the network 305. For example, a first TRP 210 may transmit the SSB 310-a, and a second TRP 210 may transmit an SSB 310-b. The measurements at the UE 115-a corresponding to the SSB 310-a may indicate information about the first TRP 210, and the measurements at the UE 115-a corresponding to the SSB 310-b may indicate information about the second TRP 210. For example, the signal strength of the SSB 310-a may be greater than the signal strength of the SSB 310-b, which may indicate that the first TRP 210 corresponds to a greater signal strength at the UE 115-a than the second TRP 210. In some examples, the UE 115-a may communicate with the first TRP 210 based on the greater signal strength.

In some implementations, the UE 115-b may report information about the measurements of the SSBs 310 to the network 305 during the initial access procedure. For example, the UE 115-b may report signal strength for each SSB 310 in a random access message 320 (e.g., random access message 320-c, a Msg3). In some cases, the UE 115-b may include information (e.g., signal strength, cell frequency) about SSBs 310 received from multiple cells or frequencies (e.g., SSBs 310 received at different cells or frequencies) in a single report (e.g., a multiple SSB report). The information for the SSBs 310, which may be across different cells, frequencies, or both, may indicate or include information related to different TRPs 210 of the network 305. Additionally, or alternatively, the information about the SSBs 310 may indicate or include information related to antenna panels at the UE 115-b. The network 305 may use the information reported by the UE 115-b to aid in enabling a multi-TRP communication scheme during the initial access procedure.

In some cases, a report from the UE 115-b may include indices to indicate the SSBs 310, and an order of the SSBs 310 in the report may implicitly indicate the signal strength (e.g., relative signal strength). For example, the UE 115-b may indicate a list of SSB indices for the SSBs 310 and respective physical cell identifiers (PCIs), frequency indicators, or a combination thereof, among other indications. Such a list may be ordered according to signal strength, implicitly indicating the comparative signal strengths of the SSBs 310. For example, the SSB 310 that is first in the list may correspond to the SSB 310 with the greatest signal strength at the UE 115-b. In some other examples, the report may include indices to indicate the SSBs 310 and explicit indications of the associated signal strength. For example, the UE 115-b may report a list of SSB indices for the SSBs 310 and an associated PCI, frequency indicator, or a combination thereof, as well as the corresponding reference signal receive power (RSRP) (e.g., layer 1 RSRP (L1-RSRP)) values, signal-to-interference-plus-noise ratio (SINR) (e.g., layer 1 SINR (L1-SINR)) values, or both for the SSBs 310. An explicit indication of the signal strength may allow the network 305 to more flexibly determine, configure, or select multi-TRP communication schemes, such as determining which TRPs 210 to use for the multi-TRP communication.

In some cases, such as for some frequency bands (e.g., FR2), the UE 115-b may indicate (e.g., additionally, in the report) whether transmission configuration indicator (TCI) states corresponding to SSBs 310 may be received simultaneously. For example, the UE 115-b may indicate that signals corresponding to the TCI states for the SSBs 310-a and 310-b may be received simultaneously, but a signal received according to a TCI state corresponding to a third SSB 310 may not be received simultaneously with the signals corresponding to the TCI states for the SSBs 310-a and 310-b. In some examples, simultaneous transmission may be implemented in the multi-TRP communication scheme, such as SDM, FDM, and SFN, and so the network 305 may use the indication of whether the TCI states corresponding to the SSBs 310 may be received simultaneously to determine whether to implement these multi-TRP communication schemes or to determine which TRPs 210 to use. For example, the network 305 may enable SDM communication at the UE 115-b via a first TRP 210 corresponding to the SSB 310-a and a second TRP 210 corresponding to the SSB 310-b, but not via a third TRP 210 corresponding to the third SSB 310. In some implementations, the format or configuration of the report may be semi-statically indicated through system information, such as a SIB (e.g., SIB 315), or may be dynamically indicated during the initial access procedure (e.g., random access message 320-b, Msg2 of a four-step random access procedure).

In some implementations, the network 305 may provide assistance information, which the UE 115-b may use to perform SSB selection or TRP 210 selection for the report. For example, the network 305 (e.g., using one or more TRPs 210) may transmit an SIB 315, which may be received by the UE 115-b. The SIB 315 may include information indicating for the UE 115-b to prioritize SSB measurement (e.g., TRP measurement) and selection for specific SSBs 310 associated with joint transmission. For example, assistance information may indicate SSBs 310 that may correspond to joint TRP downlink transmission that may not reduce effective isotropic radiated power (EIRP) at each TRP 210. Additionally, or alternatively, assistance information may indicate that some TRPs 210 at the network 305 may correspond (e.g., entirely, primarily) to uplink coverage and may have limited downlink coverage (e.g., uplink-only TRP 210, uplink-preferred TRP 210). Additionally, or alternatively, assistance information may indicate TRPs 210 that may be in a power saving mode and may not be available for communication. Additionally, or alternatively, assistance information may indicate a primary TRP 210 that may be probable or likely to perform joint transmission with a subset of TRPs 210 or for one or more frequencies or frequency bands. In some cases, a format of reporting may be indicated or configured in the SIB 315 as assistance information. For example, the assistance information may indicate a quantity of SSBs 310 corresponding to a same PCI that may be included in the report, a quantity of SSBs 310 corresponding to different PCIs but a same frequency that may be included in the report, a quantity of SSBs 310 corresponding to different frequencies that may be included in the report, or a combination thereof.

In some implementations, an initial access procedure may be a four-step random access (e.g., four-step random access channel (RACH)) procedure. The UE 115-b may transmit a first random access message 320, random access message 320-a (e.g., a Msg1). random access message 320-a may be a physical uplink control channel message (PUCCH), which may be a first random access message for the four-step random access procedure. In some cases, after receiving the random access message 320-a, the network 305 may transmit (e.g., using one or more TRPs 210) one or more additional SSBs 310, such as SSB 310-c. In some cases, in response to receiving the random access message 320-a, the network 305 may transmit (e.g., using one or more TRPs 210) a second random access message 320, random access message 320-b (e.g., a Msg2 of the four-step random access procedure). In some examples, random access message 320-b may include additional assistance information from the network 305. In some examples, the additional assistance information may be related to the one or more additional SSBs 310-c. In some cases, the UE 115-b may, responsive to receiving the random access message 320-b, transmit a third random access message 320, random access message 320-c (e.g., a Msg3 of the four-step random access procedure, an example of a random access message 225-a). random access message 320-c may be a physical uplink shared channel (PUSCH) message, and may include the report corresponding to the multi-TRP communication. In some examples, transmitting the report may be based on an RSRP of the SSBs, such that the report may be triggered by an RSRP satisfying a threshold (e.g., a threshold signaled in the SIB 315). In some cases, the network 305 may transmit (e.g., using one or more TRPs 210) a fourth random access message 320, random access message 320-d (e.g., a Msg4 of a four-step random access procedure, an example of a random access message 225-b), which may indicate to enable multi-TRP communication. For example, the random access message 320-d may include an indication to implement multi-TRP for downlink communication, uplink communication, or a combination thereof. In response, the UE 115-b may transmit a feedback message (e.g., ACK) confirming the receipt of the random access message 320-d and confirming that a multi-TRP communication scheme may be enabled. In some cases, the feedback message may be transmitted using an uplink multi-TRP communication scheme. In some cases, the random access message 320-d or parts of the random access message 320-d may be transmitted using a downlink multi-TRP communication scheme.

In some implementations, the multi-TRP communication scheme may include an SFN for joint transmission. For example, TRPs 210 of the network 305 may simultaneously transmit the same message on the same frequency. The messages from the different TRPs 210 may correspond to different quasi co-location (QCL) parameters or information, which may differentiate the SSBs 310. For example, each TRP 210 of the network 305 may transmit an SSB 310, and the QCL information of each TRP 210 may correspond to a respective SSB 310. Based on receiving the SSBs 310 from the network 305, the UE 115-b may be able to determine or derive QCL information for the multi-TRP communication, such as for SFN reception. Based on receiving the different SSBs 310, the UE 115-b may determine that there may be multiple QCL sources (e.g., multiple TRPs 210). In some cases, cyclic delay diversity (CDD) may also be implemented for signals sent via SFN, such that the messages (e.g., signals) from the different TRPs 210 may be transmitted with different delays. The UE 115-b may determine the delay values based on the SSBs 310 or the network 305 may indicate the delay values to the UE 115-b (e.g., via SIB 315), which may aid the UE 115-b in performing channel estimation and receiving messages at the UE 115-b.

The network 305 may indicate the multi-TRP communication scheme as SFN in the random access message 320-d. In some cases, the random access message 320-b may include control information (e.g., DCI) transmitted via a PDCCH and shared data transmitted via a PDSCH. The DCI for the random access message 320-d may be used to indicate the SFN. In some cases, the network 305 may transmit the DCI for random access message 320-d using a single TRP 210 (e.g., via a single-TRP communication scheme, non-SFN) to indicate the SFN, because the UE 115-b may not be prepared to receive multi-TRP communications prior to receiving the indication in the DCI. The network 305 may then transmit the shared data for random access message 320-d using the SFN. In some examples, this may be applicable to any frequency range (e.g., FR1, FR2, FR3, or a combination thereof).

In some frequency ranges (e.g., FR1, FR3), a QCL mismatch between TRPs 210 may have a minimal or small effect, and both the DCI and the shared data may be transmitted from multiple TRPs 210 that correspond to multiple QCL states. For example, a QCL mismatch between TRPs 210 may be ignored for PDCCH detection if the UE 115-b may assume the QCL for all TRPs 210 corresponds to the QCL corresponding to a primary TRP 210. In some other frequency ranges (e.g., FR2), the UE 115-b may rely on QCL information for message reception. To enable multi-TRP communication for the DCI for random access message 320-d via the SFN, the network 305 may transmit a message prior to transmitting the random access message 320-d that indicates the QCL information for the random access message 320-d DCI and shared data. For example, the network 305 may transmit a feedback message responsive to receiving the random access message 320-c, which may include the QCL information for enabling the multi-TRP communication for random access message 320-d. In some cases, multi-TRP communication may be enabled for subsequent transmissions using feedback messages or standalone messages. In other cases, the multi-TRP communication scheme may remain effective until it is canceled (e.g., for a duration of a timer, until indicated otherwise, or both).

Various multi-TRP communication schemes may be allowed or supported between the UE 115-b and the network 305. For example, SDM, FDM, intra-slot TDM, inter-slot TDM, an SFN, or a combination thereof may be supported. In some cases, FDM and TDM may include inter-frequency multi-TRP operations, for which a primary TRP 210 may operate on one frequency, and secondary TRPs 210 may operate on different frequencies. The network 305 may indicate the allowed multi-TRP communication schemes to the UE 115-b via the SIB 315 or the random access message 320-b. Additionally, or alternatively, the UE 115-b may indicate supported multi-TRP communication schemes (e.g., multi-TRP transmission modes) to the network 305 via random access message 320-c. In some cases, to allow the network 305 time to switch between beams for PDCCH and PDSCH transmissions related to the random access message 320-d, a report in the random access message 320-c may include a beam switching delay. Additionally, or alternatively, the network may use a pre-configured value, or the largest of a set of pre-configured values, as a default beam switching delay.

In some implementations, the network 305 may enable uplink multi-TRP communication, such as for the feedback message 325 (e.g., via multiple antennas panels at the UE 115-b). In order to enable uplink multi-TRP communication, the UE 115-b may report some information related to uplink transmissions to the network 305. For example, in some cases, the random access message 320-c may include uplink multi-TRP support information, which may include supported uplink multi-TRP communication schemes (e.g., SFN, SDM, FDM (with and without inter-frequency), TDM), whether simultaneous transmission may be supported at the UE 115-b (e.g., via multiple antenna panels at the UE 115-b), or both. For a four-step random access procedure, an indication to enable uplink multi-TRP communication may be included in a random access message 320-d, such as a DCI for the random access message 320-d. Additionally, or alternatively, an indication to enable downlink multi-TRP communication (e.g., for the random access message 320-d shared data) may be included in the random access message 320-d DCI, and the network 305 may include the indication to enable the uplink multi-TRP communication in the shared data of the random access message 320-d (e.g., via the PDSCH). This may reduce the overhead for the DCI of the random access message 320-d. In some cases, an uplink multi-TRP communication scheme may be enabled for subsequent uplink transmissions based on receiving an indication to enable the uplink multi-TRP scheme from the network 305. In other cases, the uplink multi-TRP communication scheme may remain effective until it is canceled (e.g., for a duration of a timer, until indicated otherwise, or both).

In some cases, downlink multi-TRP communication and uplink multi-TRP communication may be decoupled. For example, multi-TRP communication for downlink transmissions may not be related to multi-TRP communication for uplink transmissions. Thus, reports for downlink multi-TRP communication and uplink multi-TRP communication may also be decoupled.

In some implementations, enabling multi-TRP communication may increase throughput and reliability, and reduce latency, when compared to single-TRP communication. However, multi-TRP communication may, in some cases, result in increased system overhead, particularly if the network 305 and the UE 115-b may not have many, or any, messages to communicate. Thus, multi-TRP communication may be selectively configured or indicated by the network 305. For example, the network 305 may indicate, such as via SIB 315, to enable downlink multi-TRP communication, uplink multi-TRP communication, or both. Additionally, or alternatively, the network 305 may selectively activate the UE report to support multi-TRP operation. For example, the network 305 may indicate a metric or threshold that may trigger the UE multi-TRP report. For example, the measurement metric may be the RSRP of the SSBs 310. A threshold value for the RSRP may be signaled to the UE 115-b in the SIB 315. The SSBs 310 having an RSRP that satisfies (e.g., exceed) the threshold may be included in a report to the network 305. If no SSBs 310 correspond to an RSRP that satisfies the threshold, the UE 115-b may not transmit the multi-TRP report. Additionally, or alternatively, the measurement metric may be a SINR. In some examples, to indicate that a random access message 320-c may include the report, a random access occasion (RO) or preamble partition of the random access message 320-c may be used to indicate the inclusion of the multi-TRP report in the random access message 320-c.

Although multi-TRP communication may be enabled during initial access, it may be beneficial to turn off multi-TRP communication to avoid excessive overhead and power usage. For example, a multi-TRP communication scheme may be disabled based on a duration of a timer that may be based on enabling the multi-TRP communication in the initial access. When the timer expires, the network 305 and the UE 115-b may return to single-TRP communication. In some cases, the timer may be configured or indicated by the network 305 via the SIB 315 or in the random access message 320-d. The UE 115-b may start the timer when the multi-TRP communication is enabled (e.g., end of random access message 320-d DCI, random access message 320-d PDSCH). Additionally, or alternatively, the multi-TRP communication scheme may be used until the network 305 indicates a tracking reference signal (TRS) configuration to the UE 115-b. The UE 115-b may switch to the single-TRP communication after receiving a TRS configuration. Additionally, or alternatively, the UE 115-b may switch to single-TRP communication based on a combination of a timer and a TRS configuration. For example, the UE 115-b may start a timer after receiving a TRS configuration and may switch to single-TRP communication after expiration of the timer. While the multi-TRP communication scheme is enabled, the multi-TRP communication may apply to messages sent via PDCCH, PDSCH, PUSCH, PUCCH, and other signals or channels. Additionally, or alternatively, the multi-TRP communication may apply to a subset of channels, and other channels may be excluded or included based on a dynamic indication from the network 305.

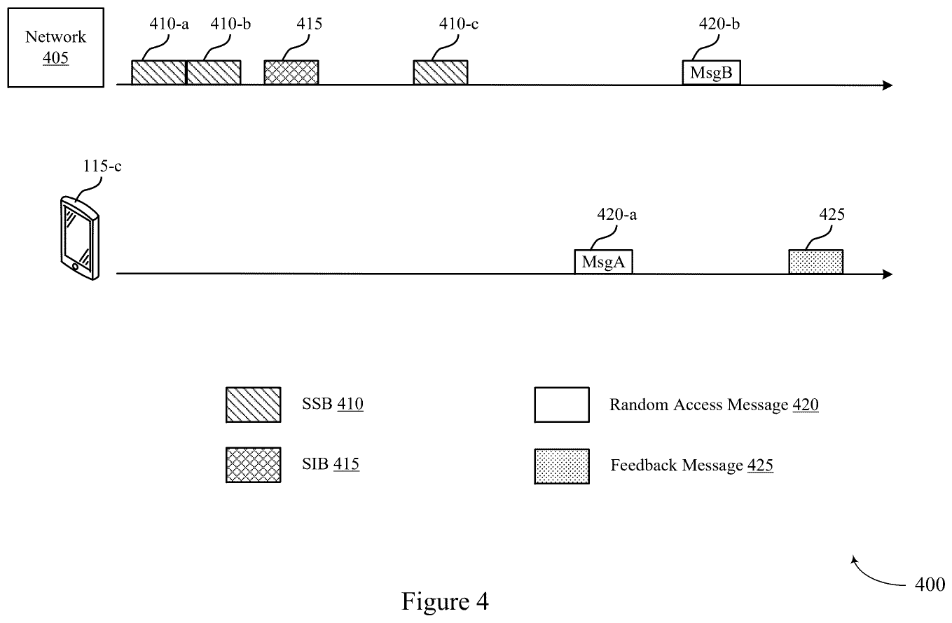

FIG. 4 shows an example of a timing diagram 400 that supports initial access for multi-TRP systems. The timing diagram 400 may implement, or be implemented by, aspects of the wireless communication system 100 or the signaling configuration 200. The techniques described in the context of the timing diagram 400 may support a network 405 (e.g., an example of a network 205) enabling multi-TRP communication with a UE 115-c during a two-step random access procedure.

In some implementations, an initial access procedure may be a two-step random access procedure. For a two-step random access procedure, information that may have been included in Msg1 and Msg3 for a four-step random access procedure may be combined into a first random access message 420 of the two-step random access procedure, random access message 420-a (e.g., a MsgA of the two-step random access procedure). Information that may have been included in Msg2 and Msg4 for a four-step random access procedure may be included in a second random access message 420 of the two-step random access procedure, random access message 420-b (e.g., a MsgB of the two-step random access procedure). random access message 420-b may be a random access response (RAR) message, responsive to random access message 420-a.

Timing diagram 400 may be an example of a two-step random access procedure that supports enabling multi-TRP communication during the two-step random access procedure. Some aspects described with respect to timing diagram 300 may also apply to timing diagram 400. For example, a two-step random access procedure may include SSBs 410 (e.g., examples of SSBs 310) transmitted from TRPs 210 of the network 405. The UE 115-c may measure the SSBs 410 and may report multi-TRP information related to the SSBs 410, as described with reference to FIG. 3. The UE 115-c may also receive a SIB 415 (e.g., SIB 315) with assistance information for reporting on the SSBs 410, and may receive one or more additional SSBs, such as SSB 410-c (e.g., SSB 310-c), after receiving the SIB 415, as described with reference to FIG. 3.

For a two-step RACH procedure, the report or information regarding the TRPs 210 of the network 405 (e.g., the multi-TRP report based on the SSBs 410-a, 410-b, and, in some examples, 410-c) may be transmitted in random access message 420-a. For example, random access message 420-a may include both a PDCCH portion and a PUSCH portion. The report may be transmitted via the PUSCH portion for random access message 420-a. As described with reference to FIG. 3, transmission of the report in random access message 420-a may be dependent on an RSRP for one or more SSBs 410 satisfying a threshold. The network 405 may include an indication of the multi-TRP communication scheme, such as enabling uplink multi-TRP communication, downlink multi-TRP communication, or both, in the random access message 420-b. For example, the indication for multi-TRP communication may be included in control information (e.g., DCI) of the random access message 420-b. In some cases, random access message 420-b may act as a feedback message for random access message 420-a. For example, the random access message 420-b may indicate successful reception of random access message 420-a. The random access message 420-b may include the indication of the multi-TRP communication scheme based on the successful random access message 420-a PUSCH reception. In some other examples, the random access message 420-b may indicate unsuccessful reception or decoding of random access message 420-a, or portions of random access message 420-a (e.g., PUSCH portion), and may indicate to fallback to a four-step random access procedure. For example, the network 405 and the UE 115-c may exchange two more random access messages 420 in accordance with the four-step random access procedure, if indicated in random access message 420-b. The two more random access messages may include the multi-TRP report, the multi-TRP enablement indication, or both, as described with reference to FIG. 3.

In some implementations, the indication for multi-TRP communication may be included in control information (e.g., DCI) of the random access message 420-b. For a four-step random access procedure, the DCI for Msg4 may include a UE-specific identifier (e.g., temporary cell radio network temporary identifier (TC-RNTI)). However, for a two-step random access procedure, the DCI of random access message 420-b may include a group identifier (e.g., random access RNTI (RA-RNTI)), which may apply to all UEs 115 corresponding to an RO. For example, multiple UEs 115 in the same RO may report different multi-TRP information via first random access messages 420-a (e.g., MsgAs) based on UE capabilities and measurements. For example, a UE 115-c may indicate, in random access message 420-a, that a first TRP 210 of the network 405 is a secondary TRP 210 for the UE 115-c. A different UE 115 may indicate, in a different random access message 420-a, that a second TRP 210 of the network 405 is a secondary TRP 210 for the different UE 115, but may not indicate the first TRP 210. To ensure the multi-TRP indications for both UEs 115 are received by the UEs 115, the network 405 may transmit random access messages 420-b for each UE 115 via respective TRPs 210 for each UE 115, may transmit multiple random access messages 420-b applicable to both UEs 115 via respective TRPs 210 for each UE 115, or may combine the random access message 420-b into one random access message 420-b for both UEs 115 using a superset of TRPs 210 for the UEs 115.

As described with reference to FIG. 3, the network 405 also may selectively configure or activate uplink multi-TRP communication, downlink multi-TRP communication, or both based on overhead and energy usage for the wireless communication system. Additionally, or alternatively, the network 405 may indicate a threshold or measurement metric (e.g., via SIB 415) that may be used to trigger the multi-TRP report from the UE 115-c in the random access message 420-a, such as an RSRP or SINR for SSBs 410. A RO or preamble partition may be used to indicate the multi-TRP report in the random access message 420-a. Additionally, or alternatively, the multi-TRP communication may be disabled after a timer duration, after a TRS configuration, or some combination of the two, as described with reference to FIG. 3.

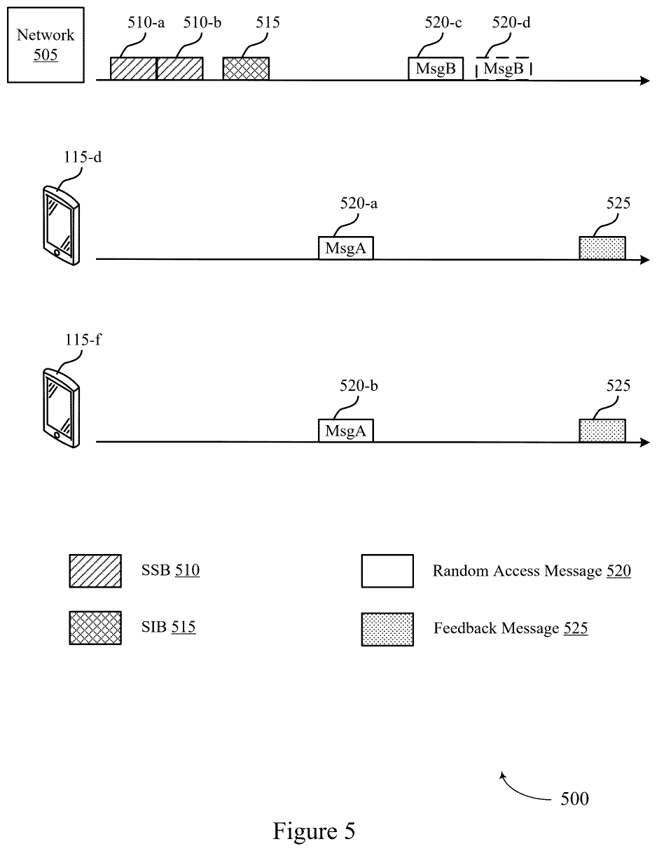

FIG. 5 shows an example of a timing diagram 500 that supports initial access for multi-TRP systems. The timing diagram 500 may implement, or be implemented by, aspects of the wireless communication system 100, the signaling configuration 200, and the timing diagrams 300 and 400. The techniques described in the context of the timing diagram 500 may support a network 505 transmitting random access messages that enable multi-TRP communication during a two-step random access procedure for multiple UEs 115, such as a UE 115-d and a UE 115-f.

In some wireless communication systems, including as described with reference to FIG. 4, an initial access procedure may include a two-step random access procedure (e.g., after transmission of SSB(s) 510, such as SSBs 510-a and 510-b, after transmission of an SIB 515, where applicable). The two step random access procedure may include transmission, by UEs 115, of a first random access messages 520 (e.g., random access message 520-a from UE 115-d and random access message 520-b from UE 115-f, each of which may be a MsgA of respective two-step random access procedures). Responsive to the first random access messages 520, the network 505 may transmit (e.g., using one or more TRPs 210) one or more second random access messages 520 (e.g., random access message 520-c and, in some examples, random access message 520-d, each of which may be a MsgB of respective two-step random access procedures). The second random access message(s) 520 may include DCI addressed to UEs 115 via an RNTI. For a two-step random access procedure, the DCI may use a RA-RNTI, which may correspond to a RO. If multiple UEs 115 use an RO, the DCI may not be specific to a particular UE 115 of the group. However, the UEs 115 may report different information regarding their capabilities and measurements for performing multi-TRP communication. For example, the UEs 115 may indicate support of multi-TRP communication with different TRPs 210, and the network 505 may transmit the second random access message 520 in accordance with reports from all UEs 115.

In some implementations, the network 505 may transmit (e.g., using one or more TRPs 210) separate MsgBs, such as random access message 520-c and random access message 520-d, addressing the UEs 115 with different multi-TRP transmission. For example, the UE 115-d may transmit a random access message 520-a, and the UE 115-f may transmit a random access message 520-b. The random access message 520-a may indicate that the UE 115-d may support multi-TRP communication with a first TRP 210 and a second TRP 210 of the network 505. The random access message 520-b may indicate that the UE 115-f may support multi-TRP communication with the first TRP 210 and a third TRP 210 of the network 505. In response, the network 505 may transmit (e.g., using one or more TRPs 210) the random access message 520-c for the UE 115-d (e.g., indicated by a preamble ID for the UE 115-d) using the first TRP 210 and the second TRP 210, in accordance with the random access message 520-a, and may transmit the random access message 520-d for the UE 115-f d (e.g., indicates by a preamble ID for the UE 115-f) via the first TRP 210 and the third TRP 210, in accordance with the random access message 520-b. If multiple UEs 115 support transmission on the same TRPs 210, the network 505 may send a single random access message 520 (e.g., a single MsgB) to those UEs 115, or the network 505 may send different random access messages 520 (e.g., different MsgBs) to UEs 115 that support different multi-TRP communication schemes. A UE 115 may monitor for a responsive random access message 520 (e.g., a random access response) until it receives a message including the preamble ID corresponding to the UE 115, or until the end of the RAR window for the first random access message 520 (e.g., for the MsgA). A UE 115 may be able to receive a responsive random access message 520 that may not be for the UE 115, but it may discard or skip the message if the preamble ID for the UE 115 is not in the message. In some cases, the responsive random access message 520 (e.g., MsgB) may indicate whether the responsive random access message 520 is a final responsive random access message 520, such that a UE 115 that may not have received an associated responsive random access message 520 may stop monitoring, even if a RAR window may not be over. In some examples, such techniques may be followed by communication of feedback message(s) 525 (e.g., in accordance with feedback message 325, feedback messages 425).

In some implementations, the network 505 may transmit (e.g., using one or more TRPs 210) multiple responsive random access message 520 (e.g., multiple MsgBs), where each responsive random access message 520 may use a different multi-TRP scheme, but each message may address all UEs 115 in an RO. For example, the network 505 may transmit the random access message 520-c using the first TRP 210 and the second TRP 210, but with preamble identifiers and associated information for both the UE 115-d and the UE 115-f. The network 505 may also transmit the random access message 520-d, via the first TRP 210 and the third TRP 210, with preamble identifiers and associated information for both the UE 115-d and the UE 115-f. This may increase the size and overhead for transmitting the responsive random access messages 520 but may increase the time diversity of the MsgB based on transmission over different TRPs 210 and may reduce UE 115-c monitoring time and energy usage. For example, if the UE 115-f receives and successfully decodes the random access message 520-c, the UE 115-c may stop monitoring for the random access message 520-d.

In some implementations, the network 505 may transmit the responsive random access messages 520 as a single message across a superset of TRPs 210 included in each report from the UEs 115. For example, the network 505 may transmit the random access message 520-c via the first TRP 210, the second TRP 210, and the third TRP 210, and may include information for both the UEs 115-d and 115-f. In some cases, a UE 115 may not be capable of receiving multi-TRP communication with a greater quantity of TRPs 210 than indicated (e.g., multiple QCL sources), and the UE 115 may fail to receive the random access message 520-c. However, transmitting the random access message 520-c across the superset of TRPs 210 may increase the probability of successful reception at the UEs 115, without transmission of extra responsive random access messages 520, if the UEs 115 support reception across the greater quantities of TRPs 210.

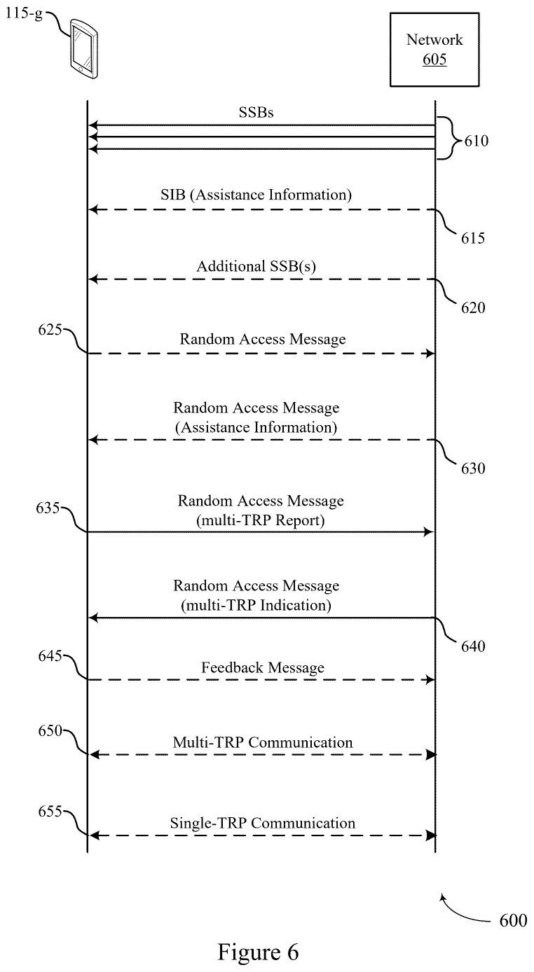

FIG. 6 shows an example of a process flow 600 that supports initial access for multi-TRP systems. The process flow 600 may implement, or be implemented by, aspects of the wireless communication system 100, the signaling configuration 200, and the timing diagrams 300, 400, and 500. The techniques described in the context of the process flow 600 may support a network 605 (e.g., an example of a network 205) enabling multi-TRP communication with a UE 115-g during an initial access procedure.

The network 605 may include multiple TRPs 210. For example, the network 605 may include multiple TRPs 210 (e.g., RUs 170, antenna panels) that may share a common CU 160, a common DU 165, or a combination thereof. In some cases, the multiple TRPs 210 may correspond to a multi-TRP communication scheme that may support communication with the network 605 via one or more of the multiple TRPs 210. In some examples, the multi-TRP communication scheme may include SDM, FDM, TDM, an SFN, or a combination thereof.

At 610, the network 605 may transmit multiple SSBs each corresponding to a respective TRP 210 of multiple TRPs 210 of the network 605, which may be received by the UE 115-g. For example, each TRP 210 of the multiple TRPs 210 may transmit an SSB of the multiple SSBs.

In some implementations, at 615, the network 605 may transmit (e.g., via an SIB) assistance information corresponding to the multiple TRPs, which may be received by the UE 115-g. The assistance information of 615 may indicate an association between the multiple SSBs and the multiple TRPs in accordance with the multi-TRP communication scheme, communication link information associated the multiple TRPs, a primary TRP of the multiple TRPs, information for a format of the first random access message, one or more supported multi-TRP communication schemes including the multi-TRP communication scheme, or a combination thereof.

In some implementations, at 620, the network 605 may transmit one or more additional SSBs, which may be received by the UE 115-g. In some such examples, the UE 115-g may measure the additional SSBs of 620.

In some implementations (e.g., in accordance with a four-step random access procedure), at 625, the UE 115-g may transmit, in response to receiving the multiple SSBs at 610, a first message of a four-step random access procedure (e.g., Msg1), which may be received by the network 605.

In some implementations (e.g., in accordance with a four-step random access procedure), at 630, the network 605 (e.g., in response to receiving the first message of 625) may transmit a second message of the four-step random access procedure (e.g., Msg2), which may be received by the UE 115-g (e.g., in response to the UE 115-g transmitting the first message of 625). In some cases, the second message may include assistance information corresponding to at least one of the multiple TRPs 210.

At 635, the UE 115-g may transmit, in response to receiving the multiple SSBs at 610, a first random access message (e.g., Msg3, MsgA) indicating a respective signal strength (e.g., RSRP, SINR) for each of the multiple TRPs 210, which may be received by the network 605. In some cases, the first random access message of 635 may include a third message of the four-step random access procedure (e.g., Msg3), and may be transmitted in response to receiving the second message of the four-step random access procedure at 630. In some other cases, the first random access message of 635 may include a first message of a two-step random access procedure (e.g., MsgA).

In some cases, the first random access message may indicate whether the UE 115-g is capable of receiving signals simultaneously via TCI states corresponding to each of the multiple SSBs simultaneously. In some cases, the first random access message may include an index of each of the multiple SSBs, an index of a cell of each of the multiple TRPs 210 (e.g., PCI), an indication of a frequency of each of the multiple TRPs 210, a respective signal strength of each of the multiple SSBs (e.g., RSRP, SINR), or a combination thereof. For example, the UE 115-g may report information related to multi-TRP communication to the network 605 via the first random access message (e.g., multi-TRP report). In some cases, the first random access message may indicate that the respective signal strength of each of multiple TRPs 210 in accordance with the respective signal strength satisfying a threshold signal strength. That is, the UE 115-g may measure the RSRP of the SSBs received at 610, which may correspond to the multiple TRPs 610, and may determine that the RSRP of each of the SSBs satisfy (e.g., exceed) the threshold signal strength. In some examples, transmitting the first random access message at 635 may be based on assistance information received at 630. In some examples, the UE 115-g may measure additional SSBs of 620 and may, in some cases, include information corresponding to the additional SSBs in the first random access message of 635. For example, the assistance information of 630 may (e.g., when communicated before or after the additional SSBs of 620) indicate information corresponding to the one or more additional SSBs at 620.

At 640, the network 605 may transmit, in response to receiving the first random access message of 635, a second random access message (e.g., Msg4, MsgB) indicating a multi-TRP communication scheme that may support communication with the network 605 via one or more of the multiple TRPs 210, which may be received by the UE 115-g (e.g., in response to transmission of the first random access message of 635).

In some cases, the second random access message may include a fourth message of the four-step random access procedure (e.g., Msg4). In other cases, the second random access message may include a second message of the two-step random access procedure and may be received in accordance with a RO for a group of UEs 115 including the UE 115-g. In some examples, the UE 115-g may receive the second message via the one or more of the multiple TRPs 210, one or more second TRPs 210 corresponding to one or more second UEs 115 of the group of UEs 115, or a combination thereof. The second message may correspond to the UE 115-g or may correspond to the group of UEs. Additionally, or alternatively, the UE 115-g may receive the second message via a second multiple TRPs 210, and the second multiple TRPs 210 (e.g., a superset of TRPs 210) may include the one or more of the multiple TRPs 210 and one or more second TRPs 210 corresponding to at least a second multi-TRP communication scheme for the group of UEs 115. For example, as described with reference to FIG. 5, the second message of the two-step random access procedure may be transmitted to a group of UEs 115, so the network 605 may transmit multiple second messages via different sets of TRPs 210, may combine the second messages for the UEs 115 across a superset of TRPs 210, or a combination thereof.

In some cases, to receive the second random access message at 640, the UE 115-g may receive control information (e.g., DCI via PDCCH) of the second random access message in accordance with a single-TRP communication scheme that supports communication with the network 605 via one of the multiple TRPs 210. The control information may indicate the multi-TRP communication scheme, and the UE 115-g may receive shared data (e.g., via a PDSCH) of the second random access message in accordance with the multi-TRP communication scheme. In some cases, the second random access message may indicate that the multi-TRP communication scheme supports uplink communication.

In some implementations, at 645, the UE 115-g may transmit, based on the multi-TRP communication scheme supporting uplink communication, a feedback message indicating successful reception of the second random access message at 640, which may be received by the network 605.

In some implementations, at 650, the UE 115-g may communicate with the network 605 via the one or more of the multiple TRPs 210 and in accordance with the multi-TRP communication scheme.

In some cases, the UE 115-g may communicate in accordance with the multi-TRP communication scheme based on receiving the second random access message at 640 and in accordance with QCL information. For example, the second random access message of 640 may include QCL information, and the UE 115-g may communicate (e.g., with the network 605) in accordance with the multi-TRP communication scheme based on receiving the second random access message and in accordance with the QCL information.

In some implementations, at 655, the UE 115-g may communicate with the network 605 via a single TRP 210 of a single-TRP communication scheme based on an expiration of a timer for communicating in accordance with the multi-TRP communication scheme, a reference signal configuration, or a combination thereof. For example, the timer may be started when the multi-TRP communication scheme is enabled and the single-TRP communication scheme may be enabled after expiration of the timer. Additionally, or alternatively, the single-TRP communication scheme may be enabled after receiving the reference signal configuration (e.g., TRS configuration). Additionally, or alternatively, the timer may be started after receiving the reference signal configuration, and the single-TRP communication scheme may be enabled after expiration of the timer.

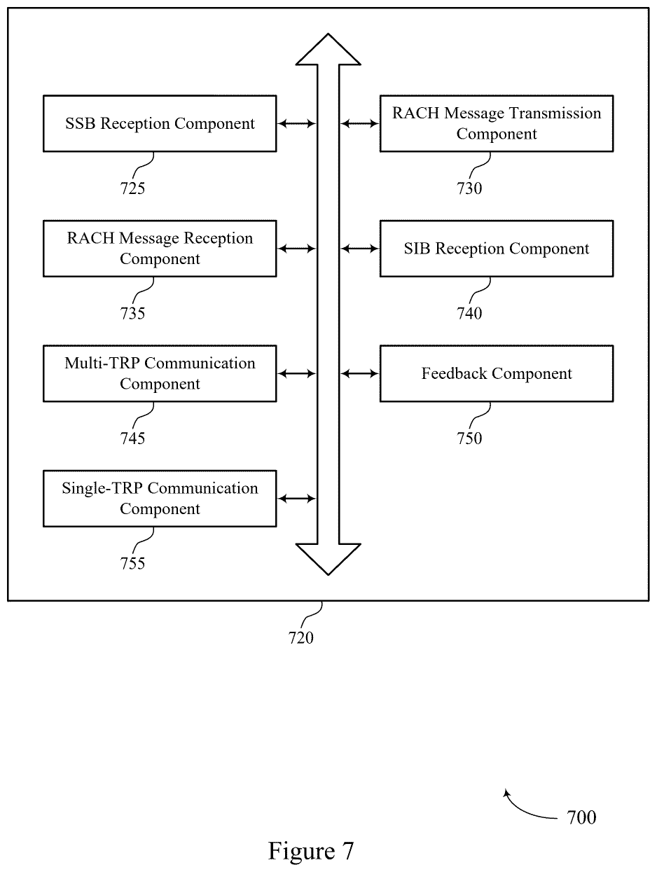

FIG. 7 shows an example 700 of a processing system 720 that supports initial access for multi-TRP systems. A processing system 720 may be an example of a processing system 140 (such as of a UE 115) and may include an SSB reception component 725, a RACH message transmission component 730, a RACH message reception component 735, an SIB reception component 740, a multi-TRP communication component 745, a feedback component 750, a single-TRP communication component 755, or any combination thereof. A processing system 720, or various component thereof, may be an example of means for performing (such as a means for causing a UE 115 to perform) various techniques described herein.

The SSB reception component 725 may be configured to cause the UE 115 to receive a set of multiple SSBs each corresponding to a respective TRP of a set of multiple TRPs of a network. The RACH message transmission component 730 may be configured to cause the UE 115 to transmit, in response to receiving the set of multiple SSBs, a first random access message indicating a respective signal strength for each of the set of multiple TRPs. The RACH message reception component 735 may be configured to cause the UE 115 to receive, in response to transmitting the first random access message, a second random access message indicating a multi-TRP communication scheme that supports communication with the network via one or more of the set of multiple TRPs.

In some examples, the SIB reception component 740 may be configured to cause the UE 115 to receive, via a SIB, assistance information corresponding to the set of multiple TRPs, and the first random access message may be based on the assistance information.

In some examples, the assistance information indicates an association between the set of multiple SSBs and the set of multiple TRPs in accordance with the multi-TRP communication scheme, communication link information associated the set of multiple TRPs, a primary TRP of the set of multiple TRPs, information for a format of the first random access message, one or more supported multi-TRP communication schemes including the multi-TRP communication scheme, or a combination thereof.

In some examples, the second random access message includes QCL information for each of the set of multiple TRPs, and the multi-TRP communication component 745 may be configured to cause the UE 115 to communicate in accordance with the multi-TRP communication scheme based on receiving the second random access message and in accordance with the QCL information.

In some examples, to support receiving the second random access message, the RACH message reception component 735 may be configured to cause the UE 115 to receive control information of the second random access message in accordance with a single-TRP communication scheme that supports communication with the network via one of the set of multiple TRPs, and the control information may indicate the multi-TRP communication scheme. In some examples, to support receiving the second random access message, the RACH message reception component 735 may be configured to cause the UE 115 to receive shared data of the second random access message in accordance with the multi-TRP communication scheme.

In some examples, the first random access message includes a third message of a four-step random access procedure and the second random access message includes a fourth message of the four-step random access procedure, and the RACH message transmission component 730 may be configured to cause the UE 115 to transmit, in response to receiving the set of multiple SSBs, a first message of the four-step random access procedure. In some examples, the first random access message includes a third message of a four-step random access procedure and the second random access message includes a fourth message of the four-step random access procedure, and the RACH message reception component 735 may be configured to cause the UE 115 to receive, in response to transmitting the first message, a second message of the four-step random access procedure, and the third message may be transmitted in response to receiving the second message.

In some examples, the second message includes assistance information corresponding to at least one of the set of multiple TRPs, and the third message is based on the assistance information.

In some examples, the first random access message includes a first message of a two-step random access procedure and the second random access message includes a second message of the two-step random access procedure, the second message received in accordance with a random access opportunity (e.g., an RO) for a group of UEs including the UE.

In some examples, to support receiving the second random access message, the RACH message reception component 735 may be configured to cause the UE 115 to receive the second message via the one or more of the set of multiple TRPs, one or more second TRPs corresponding to one or more second UEs of the group of UEs, or a combination thereof, and the second message may corresponds to the UE or may correspond to the group of UEs.

In some examples, to support receiving the second random access message, the RACH message reception component 735 may be configured to cause the UE 115 to receive the second message via a second set of multiple TRPs, and the second set of multiple TRPs may include the one or more of the set of multiple TRPs and one or more second TRPs corresponding to at least a second multi-TRP communication scheme for the group of UEs.

In some examples, the second random access message indicates that the multi-TRP communication scheme supports uplink communication, and the feedback component 750 may be configured to cause the UE 115 to transmit, based on the multi-TRP communication scheme supporting uplink communication, a feedback message indicating successful reception of the second random access message.

In some examples, the first random access message further indicates whether the UE is capable of receiving signals simultaneously via TCI states corresponding to each of the set of multiple SSBs.

In some examples, the first random access message includes an index of each of the set of multiple SSBs, an index of a cell of each of the set of multiple TRPs, an indication of a frequency of each of the set of multiple TRPs, a respective signal strength of each of the set of multiple SSBs, or a combination thereof.

In some examples, the first random access message indicates the respective signal strength of each of the set of multiple TRPs in accordance with the respective signal strength satisfying a threshold signal strength.

In some examples, the multi-TRP communication component 745 may be configured to cause the UE 115 to communicate with the network via the one or more of the plurality TRPs and in accordance with the multi-TRP communication scheme. In some examples, the single-TRP communication component 755 may be configured to cause the UE 115 to communicate with the network via a single TRP of a single-TRP communication scheme based on an expiration of a timer for communicating in accordance with the multi-TRP communication scheme, a reference signal configuration, or a combination thereof.

In some examples, the multi-TRP communication scheme includes SDM, FDM, TDM, an SFN, or a combination thereof.

In some examples, the set of multiple TRPs of the network share a common CU, a common DU, or a combination thereof.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques for reduced latency, more efficient utilization of communication resources, improved coordination between devices, and improved utilization of processing capability.

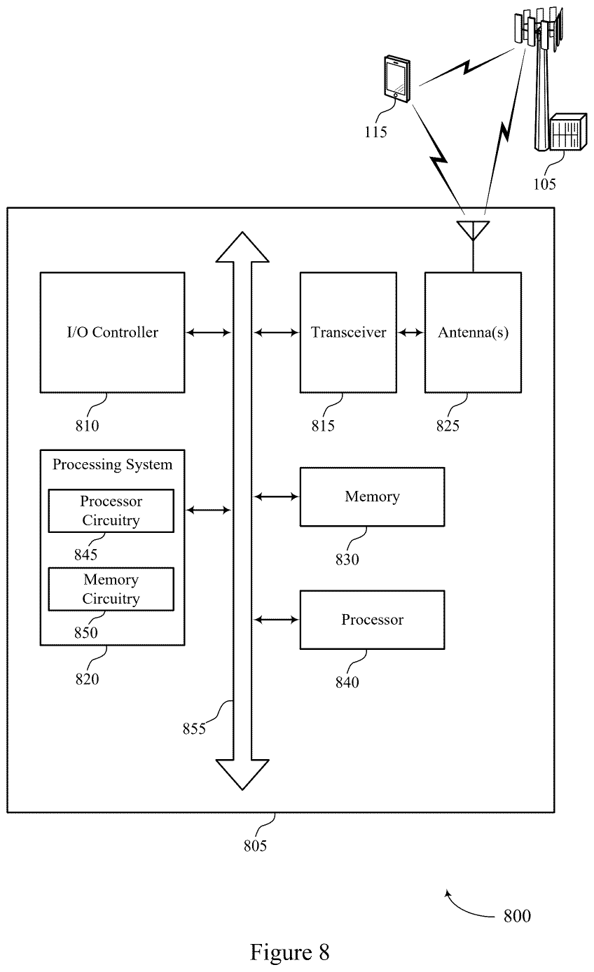

FIG. 8 shows an example of a system 800 including a device 805 that supports initial access for multi-TRP systems. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840 (e.g., directly, indirectly, without pre-processing, after pre-processing), cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 720. For example, the processing system 820 may include processor circuitry 845 and memory circuitry 850 that stores code, and may be configured to cause the device 805 to perform operations that support initial access for multi-TRP systems. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for reduced latency, more efficient utilization of communication resources, improved coordination between devices, and improved utilization of processing capability.

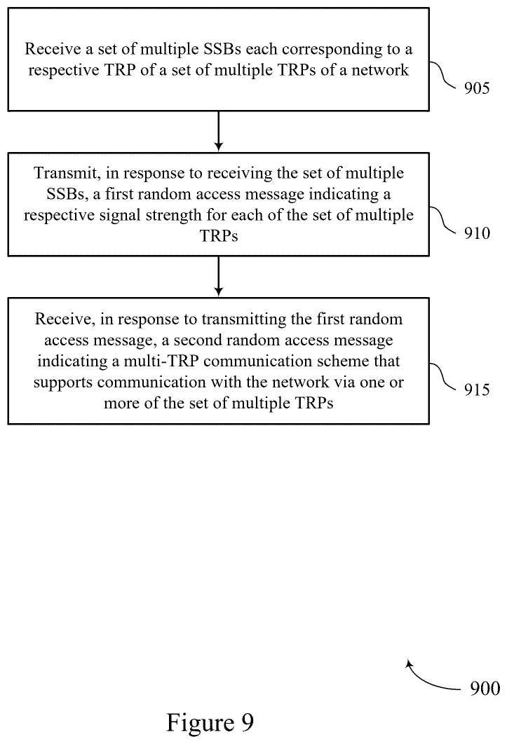

FIG. 9 shows an example of a method 900 that supports initial access for multi-TRP systems. Operations of the method 900 may be performed by a UE or its components (such as using a processing system configured to cause the UE 115 to perform one or more of the operations) as described herein.

At 905, the method may include receiving a set of multiple SSBs each corresponding to a respective TRP of a set of multiple TRPs of a network. In some examples, aspects of the operations of 905 may be performed by an SSB reception component 725.

At 910, the method may include transmitting, in response to receiving the set of multiple SSBs, a first random access message indicating a respective signal strength for each of the set of multiple TRPs. In some examples, aspects of the operations of 910 may be performed by a RACH message transmission component 730.

At 915, the method may include receiving, in response to transmitting the first random access message, a second random access message indicating a multi-TRP communication scheme that supports communication with the network via one or more of the set of multiple TRPs. In some examples, aspects of the operations of 915 may be performed by a RACH message reception component 735.

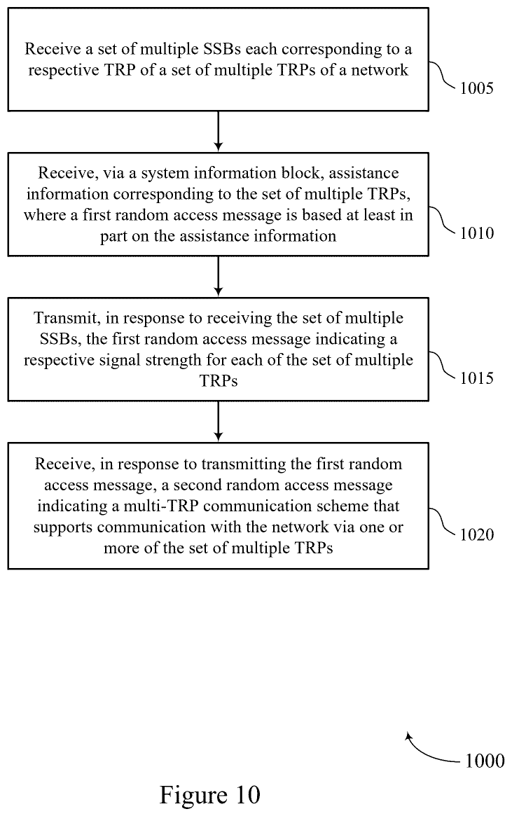

FIG. 10 shows an example of a method 1000 that supports initial access for multi-TRP systems. Operations of the method 1000 may be performed by a UE or its components (such as using a processing system configured to cause the UE 115 to perform one or more of the operations) as described herein.

At 1005, the method may include receiving a set of multiple SSBs each corresponding to a respective TRP of a set of multiple TRPs of a network. In some examples, aspects of the operations of 1005 may be performed by an SSB reception component 725.

At 1010, the method may include receiving, via a SIB, assistance information corresponding to the set of multiple TRPs, where a first random access message is based at least in part on the assistance information. In some examples, aspects of the operations of 1010 may be performed by an SIB reception component 740.

At 1015, the method may include transmitting, in response to receiving the set of multiple SSBs, the first random access message indicating a respective signal strength for each of the set of multiple TRPs. In some examples, aspects of the operations of 1015 may be performed by a RACH message transmission component 730.

At 1020, the method may include receiving, in response to transmitting the first random access message, a second random access message indicating a multi-TRP communication scheme that supports communication with the network via one or more of the set of multiple TRPs. In some examples, aspects of the operations of 1020 may be performed by a RACH message reception component 735.

Implementation examples are described in the following numbered clauses:
Aspect 1: A method for wireless communications at a UE, comprising: receiving a plurality of SSBs each corresponding to a respective TRP of a plurality of TRPs of a network; transmitting, in response to receiving the plurality of SSBs, a first random access message indicating a respective signal strength for each of the plurality of TRPs; and receiving, in response to transmitting the first random access message, a second random access message indicating a multi-TRP communication scheme that supports communication with the network via one or more of the plurality of TRPs.
Aspect 2: The method of aspect 1, further comprising: receiving, via a SIB, assistance information corresponding to the plurality of TRPs, wherein the first random access message is based at least in part on the assistance information.
Aspect 3: The method of aspect 2, wherein the assistance information indicates an association between the plurality of SSBs and the plurality of TRPs in accordance with the multi-TRP communication scheme, communication link information associated the plurality of TRPs, a primary TRP of the plurality of TRPs, information for a format of the first random access message, one or more supported multi-TRP communication schemes including the multi-TRP communication scheme, or a combination thereof.
Aspect 4: The method of any of aspects 1 through 3, wherein the second random access message comprises QCL information for each of the plurality of TRPs, the method further comprising: communicating in accordance with the multi-TRP communication scheme based at least in part on receiving the second random access message and in accordance with the QCL information.
Aspect 5: The method of any of aspects 1 through 4, wherein receiving the second random access message comprises: receiving control information of the second random access message in accordance with a single-TRP communication scheme that supports communication with the network via one of the plurality of TRPs, wherein the control information indicates the multi-TRP communication scheme; and receiving shared data of the second random access message in accordance with the multi-TRP communication scheme.
Aspect 6: The method of any of aspects 1 through 5, wherein the first random access message comprises a third message of a four-step random access procedure and the second random access message comprises a fourth message of the four-step random access procedure, the method further comprising: transmitting, in response to receiving the plurality of SSBs, a first message of the four-step random access procedure; and receiving, in response to transmitting the first message, a second message of the four-step random access procedure, wherein the third message is transmitted in response to receiving the second message.
Aspect 7: The method of aspect 6, wherein the second message comprises assistance information corresponding to at least one of the plurality of TRPs, and the third message is based at least in part on the assistance information.
Aspect 8: The method of any of aspects 1 through 5, wherein the first random access message comprises a first message of a two-step random access procedure and the second random access message comprises a second message of the two-step random access procedure, the second message received in accordance with a RO for a group of UEs comprising the UE.
Aspect 9: The method of aspect 8, wherein receiving the second random access message comprises: receiving the second message via the one or more of the plurality of TRPs, one or more second TRPs corresponding to one or more second UEs of the group of UEs, or a combination thereof, wherein the second message corresponds to the UE or corresponds to the group of UEs.
Aspect 10: The method of any of aspects 8 through 9, wherein receiving the second random access message comprises: receiving the second message via a second plurality of TRPs, wherein the second plurality of TRPs comprises the one or more of the plurality of TRPs and one or more second TRPs corresponding to at least a second multi-TRP communication scheme for the group of UEs.
Aspect 11: The method of any of aspects 1 through 10, wherein the second random access message indicates that the multi-TRP communication scheme supports uplink communication, the method further comprising: transmitting, based at least in part on the multi-TRP communication scheme supporting uplink communication, a feedback message indicating successful reception of the second random access message.
Aspect 12: The method of any of aspects 1 through 11, wherein the first random access message further indicates whether the UE is capable of receiving signals simultaneously via TCI states corresponding to each of the plurality of SSBs.
Aspect 13: The method of any of aspects 1 through 12, wherein the first random access message comprises an index of each of the plurality of SSBs, an index of a cell of each of the plurality of TRPs, an indication of a frequency of each of the plurality of TRPs, a respective signal strength of each of the plurality of SSBs, or a combination thereof.
Aspect 14: The method of any of aspects 1 through 13, wherein the first random access message indicates the respective signal strength of each of the plurality of TRPs in accordance with the respective signal strength satisfying a threshold signal strength.
Aspect 15: The method of any of aspects 1 through 14, further comprising: communicating with the network via the one or more of the plurality TRPs and in accordance with the multi-TRP communication scheme; and communicating with the network via a single TRP of a single-TRP communication scheme based at least in part on an expiration of a timer for communicating in accordance with the multi-TRP communication scheme, a reference signal configuration, or a combination thereof.
Aspect 16: The method of any of aspects 1 through 15, wherein the multi-TRP communication scheme comprises SDM, FDM, TDM, an SFN, or a combination thereof.
Aspect 17: The method of any of aspects 1 through 16, wherein the plurality of TRPs of the network share a common CU, a common DU, or a combination thereof.
Aspect 18: A UE for wireless communications, comprising a processing system that includes processor circuitry and memory circuitry that stores code, the processing system configured to cause the UE to perform a method of any of aspects 1 through 17.
Aspect 19: A UE for wireless communications, comprising at least one means for performing a method of any of aspects 1 through 17.
Aspect 20: A non-transitory computer-readable medium storing code for wireless communications, the code comprising instructions executable by one or more processors to perform a method of any of aspects 1 through 17.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a plurality of synchronization signal blocks (SSBs) each corresponding to a respective transmission and reception point (TRP) of a plurality of TRPs of a network;
transmit, in response to receiving the plurality of SSBs, a first random access message indicating a respective signal strength for each of the plurality of TRPs; and
receive, in response to transmitting the first random access message, a second random access message indicating a multiple-TRP (multi-TRP) communication scheme that supports communication with the network via one or more of the plurality of TRPs.

2. The UE of claim 1, wherein the processing system is further configured to cause the UE to:
receive, via a system information block, assistance information corresponding to the plurality of TRPs, wherein the first random access message is based at least in part on the assistance information.

3. The UE of claim 2, wherein the assistance information indicates an association between the plurality of SSBs and the plurality of TRPs in accordance with the multi-TRP communication scheme, communication link information associated the plurality of TRPs, a primary TRP of the plurality of TRPs, information for a format of the first random access message, one or more supported multi-TRP communication schemes including the multi-TRP communication scheme, or a combination thereof.

4. The UE of claim 1, wherein the second random access message comprises quasi co-location information for each of the plurality of TRPs, and the processing system is further configured to cause the UE to:
communicate in accordance with the multi-TRP communication scheme based at least in part on receiving the second random access message and in accordance with the quasi co-location information.

5. The UE of claim 1, wherein, to receive the second random access message, the processing system is configured to cause the UE to:
receive control information of the second random access message in accordance with a single-TRP communication scheme that supports communication with the network via one of the plurality of TRPs, wherein the control information indicates the multi-TRP communication scheme; and
receive shared data of the second random access message in accordance with the multi-TRP communication scheme.

6. The UE of claim 1, wherein the first random access message comprises a third message of a four-step random access procedure and the second random access message comprises a fourth message of the four-step random access procedure, and the processing system is further configured to cause the UE to:
transmit, in response to receiving the plurality of SSBs, a first message of the four-step random access procedure; and
receive, in response to transmitting the first message, a second message of the four-step random access procedure, wherein the third message is transmitted in response to receiving the second message.

7. The UE of claim 6, wherein the second message comprises assistance information corresponding to at least one of the plurality of TRPs, and the third message is based at least in part on the assistance information.

8. The UE of claim 1, wherein the first random access message comprises a first message of a two-step random access procedure and the second random access message comprises a second message of the two-step random access procedure, the second message received in accordance with a random access occasion for a group of UEs comprising the UE.

9. The UE of claim 8, wherein, to receive the second random access message, the processing system is configured to cause the UE to:
receive the second message via the one or more of the plurality of TRPs, one or more second TRPs corresponding to one or more second UEs of the group of UEs, or a combination thereof, wherein the second message corresponds to the UE or corresponds to the group of UEs.

10. The UE of claim 8, wherein, to receive the second random access message, the processing system is configured to cause the UE to:
receive the second message via a second plurality of TRPs, wherein the second plurality of TRPs comprises the one or more of the plurality of TRPs and one or more second TRPs corresponding to at least a second multi-TRP communication scheme for the group of UEs.

11. The UE of claim 1, wherein the second random access message indicates that the multi-TRP communication scheme supports uplink communication, and the processing system is further configured to cause the UE to:
transmit, based at least in part on the multi-TRP communication scheme supporting uplink communication, a feedback message indicating successful reception of the second random access message.

12. The UE of claim 1, wherein the first random access message further indicates whether the UE is capable of receiving signals simultaneously via transmission configuration indicator states corresponding to each of the plurality of SSBs.

13. The UE of claim 1, wherein the first random access message comprises an index of each of the plurality of SSBs, an index of a cell of each of the plurality of TRPs, an indication of a frequency of each of the plurality of TRPs, a respective signal strength of each of the plurality of SSBs, or a combination thereof.

14. The UE of claim 1, wherein the first random access message indicates the respective signal strength of each of the plurality of TRPs in accordance with the respective signal strength satisfying a threshold signal strength.

15. The UE of claim 1, wherein the processing system is further configured to cause the UE to:
communicate with the network via the one or more of the plurality TRPs and in accordance with the multi-TRP communication scheme; and
communicate with the network via a single TRP of a single-TRP communication scheme based at least in part on an expiration of a timer for communicating in accordance with the multi-TRP communication scheme, a reference signal configuration, or a combination thereof.

16. The UE of claim 1, wherein the multi-TRP communication scheme comprises space division multiplexing, frequency division multiplexing, time division multiplexing, a single frequency network, or a combination thereof.

17. The UE of claim 1, wherein the plurality of TRPs of the network share a common central unit, a common distributed unit, or a combination thereof.

18. A method for wireless communications at a user equipment (UE), comprising:
receiving a plurality of synchronization signal blocks (SSBs) each corresponding to a respective transmission and reception point (TRP) of a plurality of TRPs of a network;
transmitting, in response to receiving the plurality of SSBs, a first random access message indicating a respective signal strength for each of the plurality of TRPs; and
receiving, in response to transmitting the first random access message, a second random access message indicating a multiple-TRP (multi-TRP) communication scheme that supports communication with the network via one or more of the plurality of TRPs.

19. The method of claim 18, further comprising:
receiving, via a system information block, assistance information corresponding to the plurality of TRPs, wherein the first random access message is based at least in part on the assistance information.

20. A non-transitory computer-readable medium storing code for wireless communications at a user equipment (UE), the code comprising instructions executable by one or more processors to:
receive a plurality of synchronization signal blocks (SSBs) each corresponding to a respective transmission and reception point (TRP) of a plurality of TRPs of a network;
transmit, in response to receiving the plurality of SSBs, a first random access message indicating a respective signal strength for each of the plurality of TRPs; and
receive, in response to transmitting the first random access message, a second random access message indicating a multiple-TRP (multi-TRP) communication scheme that supports communication with the network via one or more of the plurality of TRPs.
